(19) United States
(12) Patent Application Publication
(10) Pub. No.: US 2024/0331440 A1
(43) Pub. Date: Oct. 3, 2024

(54) IMAGE DETECTING METHOD AND IMAGE DETECTING APPARATUS

(71) Applicant: HIMAX TECHNOLOGIES LIMITED, Tainan City (TW)

(72) Inventor: Keng-Chih Chen, Tainan City (TW)

(73) Assignee: HIMAX TECHNOLOGIES LIMITED, Tainan City (TW)

(21) Appl. No.: 18/190,894

(22) Filed: Mar. 27, 2023

(51) Int. Cl. G06V 40/16; G06V 10/25; G10L 25/78; H04R 1/40; H04R 3/00

(52) U.S. Cl. CPC G06V 40/166; G06V 10/25; G10L 25/78; H04R 1/406; H04R 3/005

(57) ABSTRACT

The image detecting apparatus including an image capturing device, a microphone array and a processing circuit is provided. The image capturing device captures an image. The microphone array detects a voice source. The processing circuit performs a voice activity detection on a first number of voice signals captured by the microphone devices to determine whether the voice source is a preset type voice. The processing circuit performs a beamforming operation on a second number of voice signals captured by the microphone devices to generate a region of interest (ROI) setting signal when the voice source is the preset type voice. The ROI setting signal indicates a location of the voice source in the image. The processing circuit performs an image detecting operation on a ROI image. The ROI image is determined according to the image and the ROI setting signal. The first number is smaller than the second number.

### BACKGROUND

### Technical Field

The invention relates to a detecting method and a detecting apparatus, and in particular, to an image detecting method and an image detecting apparatus.

### Description of Related Art

As application of image detecting apparatuses develops, performance requirements of the image detecting apparatuses increase. For example, as sizes of image regions to be detected increase, or the number of classification categories and feature complexity increase, the performance requirements of the image detecting apparatuses increase. However, it may take a lot of operational time and/or power consumption transmission for detecting a whole input image.

### SUMMARY

The invention is directed to an image detecting method and an image detecting apparatus, capable of reducing power consumption and operational time of image detecting.

An embodiment of the invention provides an image detecting method, adapted to an image detecting apparatus. The image detecting apparatus includes an image capturing device and a microphone array. The microphone array has a plurality of microphone devices. The image detecting method includes: performing a voice activity detection (VAD) on a first number of voice signals captured by the corresponding microphone devices to determine whether the voice source is a preset type voice, wherein the voice signals are from the voice source; performing a beamforming operation on a second number of voice signals captured by the corresponding microphone devices to generate a region of interest (ROI) setting signal when the voice source is the preset type voice, wherein the ROI setting signal indicates a location of the voice source in an image captured by the image capturing device; and performing an image detecting operation on a ROI image, wherein the ROI image is determined according to the image and the ROI setting signal. The first number is smaller than the second number.

In an embodiment of the invention, the image detecting method further includes: only activating the first number of the microphone devices for the VAD; and only activating the second of the microphone devices for the beamforming operation.

In an embodiment of the invention, the step of performing the VAD on the first number of voice signals captured by the corresponding microphone devices to determine whether the voice source is the preset type voice includes: controlling the first number of the microphone devices to detect the voice source in a periodic time.

In an embodiment of the invention, the image detecting method further includes: performing the VAD to further confirm whether the voice source is the preset type voice on a voice fusion, wherein the voice fusion is generated from the beamforming operation.

In an embodiment of the invention, when the location of the voice source and a type of the voice source are not confirmed for a preset time length, a whole region of the image is determined as the ROI image.

In an embodiment of the invention, the step of performing the image detecting operation on the ROI image includes: capturing the whole image, and determining the ROI image according to the ROI setting signal and the received whole image.

In an embodiment of the invention, the step of performing the image detecting operation on the ROI image includes: capturing the ROI of the image according to the ROI setting signal.

In an embodiment of the invention, the ROI of the image is configured for face recognition.

An embodiment of the invention provides an image detecting apparatus. The image detecting apparatus includes an image capturing device, a microphone array and a processing circuit. The image capturing device is configured to capture an image. The microphone array has a plurality of microphone devices. The microphone array is configured to detect a voice source. The processing circuit is coupled to the image capturing device and the microphone array. The processing circuit is configured to perform a voice activity detection (VAD) on a first number of voice signals captured by the corresponding microphone devices to determine whether the voice source is a preset type voice. The processing circuit is configured to perform a beamforming operation on a second number of voice signals captured by the corresponding microphone devices to generate a region of interest (ROI) setting signal when the voice source is the preset type voice. The voice signals are from the voice source. The ROI setting signal indicates a location of the voice source in the image. The processing circuit is configured to perform an image detecting operation on a ROI image. The ROI image is determined according to the image and the ROI setting signal. The first number is smaller than the second number.

In an embodiment of the invention, the processing circuit only activates the first number of the microphone devices for the VAD, and only activates the second of the microphone devices for the beamforming operation.

In an embodiment of the invention, the processing circuit controls the first number of the microphone devices to detect the voice source in a periodic time.

In an embodiment of the invention, the processing circuit performs the VAD to further confirm whether the voice source is the preset type voice on a voice fusion. The voice fusion is generated from the beamforming operation.

In an embodiment of the invention, when the location of the voice source and a type of the voice source are not confirmed for a preset time length, the processing circuit determines a whole region of the image as the ROI image.

In an embodiment of the invention, the processing circuit controls the image capturing device to capture the whole image, and determines the ROI image according to the ROI setting signal and the received whole image.

In an embodiment of the invention, the processing circuit controls the image capturing device to capture the ROI image according to the ROI setting signal.

In an embodiment of the invention, the processing circuit performs a face recognition operation according to the ROI image.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a block diagram of an image detecting apparatus according to an embodiment of the invention.

FIG. 2 illustrates a schematic diagram of a captured image according to an embodiment of the invention.

FIG. 3 illustrates a detail block diagram of the processing circuit of FIG. 1 according to an embodiment of the invention.

FIG. 4 is a flowchart illustrating an image detecting method according to an embodiment of the invention.

FIG. 5 is a flowchart illustrating an image detecting method according to another embodiment of the invention.

FIG. 6 is a flowchart illustrating an image detecting method according to another embodiment of the invention.

### DESCRIPTION OF THE EMBODIMENTS

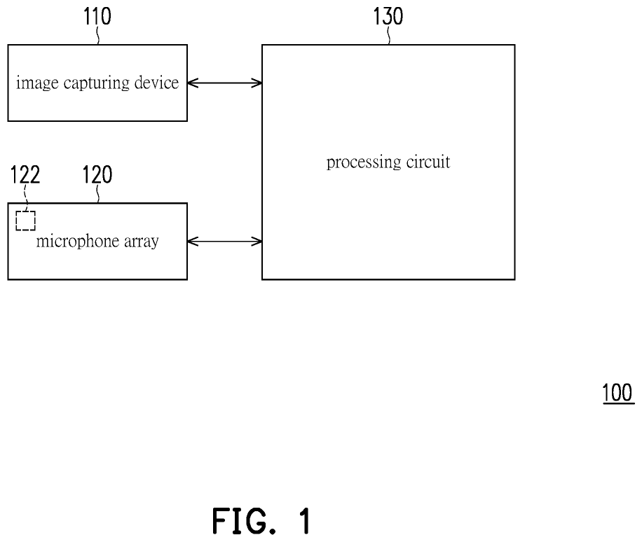

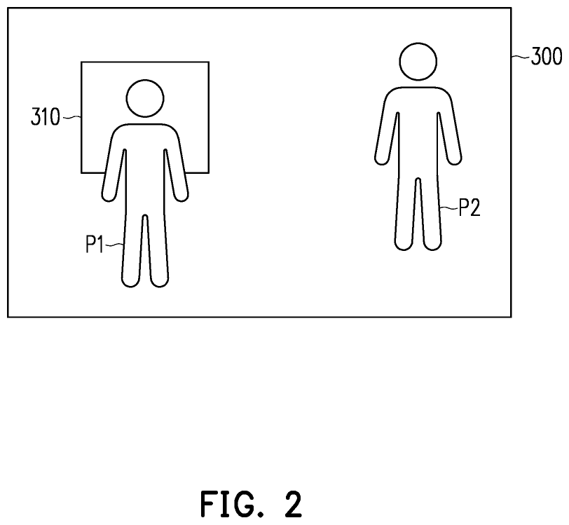

FIG. 1 illustrates a block diagram of an image detecting apparatus according to an embodiment of the invention. FIG. 2 illustrates a schematic diagram of a captured image according to an embodiment of the invention. Referring to FIG. 1 and FIG. 2, the image detecting apparatus 100 includes an image capturing device 110, a microphone array 120 and a processing circuit 130. The image capturing device 110 is configured to capture an image 300. The microphone array 120 is configured to detect a voice source. The microphone array 120 has a plurality of microphone devices arranged in an array. Only one microphone device 122 is illustrated in FIG. 1 as an example.

In FIG. 2, the captured image 300 includes two persons P1 and P2. The voice source may from the person P1, and a ROI image 310 is determined according to the image 300 and a ROI setting signal. In the present embodiment, the ROI image 310 is a part region of the image 300, but the invention is not limited thereto. In a specific condition, a whole region of the image 300 may be determined as the ROI image 310.

The processing circuit 130 is coupled to the image capturing device 110 and the microphone array 120. The processing circuit 130 is configured to control operations of the image capturing device 110 and the microphone array 120.

To be specific, the processing circuit 130 may only activates a first number of the microphone devices 122 for a voice activity detection (VAD). The processing circuit 130 is configured to perform the VAD on the first number of voice signals to determine whether the voice source is a preset type voice. The voice signals are from the voice source of the person P1, and thus the preset type voice is human voice. The first number of voice signals are captured by the corresponding microphone devices 122, e.g. the first number of the activated microphone devices 122.

When the voice source is determined as the preset type voice, the processing circuit 130 further activates only a second number of the microphone devices 122. The first number of the activated microphone devices 122 is smaller than the second number of the activated microphone devices 122. Then the processing circuit 130 is configured to perform a beamforming (or spatial filtering) operation on the second number of voice signals to generate the ROI setting signal. The second number of voice signals are captured by the corresponding microphone devices 122, e.g. the second number of the activated microphone devices 122. The ROI setting signal indicates a location of the voice source in the image 300. The ROI image 310 is determined according to the image 300 from the image capturing device 110 and the ROI setting signal. In another embodiment, the image capturing device 110 may activate the image sensing circuit in the ROI according to the ROI setting signal from the processing circuit 130. The processing circuit 130 is configured to perform an image detecting operation on the ROI image. It is noted that the first number is smaller than the second number. Hereinafter for brief, the first number is one and the second number is all microphone devices 122.

In an embodiment, the image detecting apparatus 100 may be applied to video identification devices, such as doorbell, notebooks or home appliances under standby modes, which have low power requirements. Accordingly, the processing circuit 130 may perform a face recognition operation according to the ROI of the image. The invention does not intend to limit applications of the image detecting apparatus 100.

In an embodiment, the image capturing device 110 may include optical sensors and/or space sensors, such as time-of-flight sensors (ToF sensors) or mmWave sensors. Accordingly, the image detecting apparatus 100 may detect 2D or 3D images, and thus the ROI of the 2D or 3D images can be determined according to the ROI setting signal.

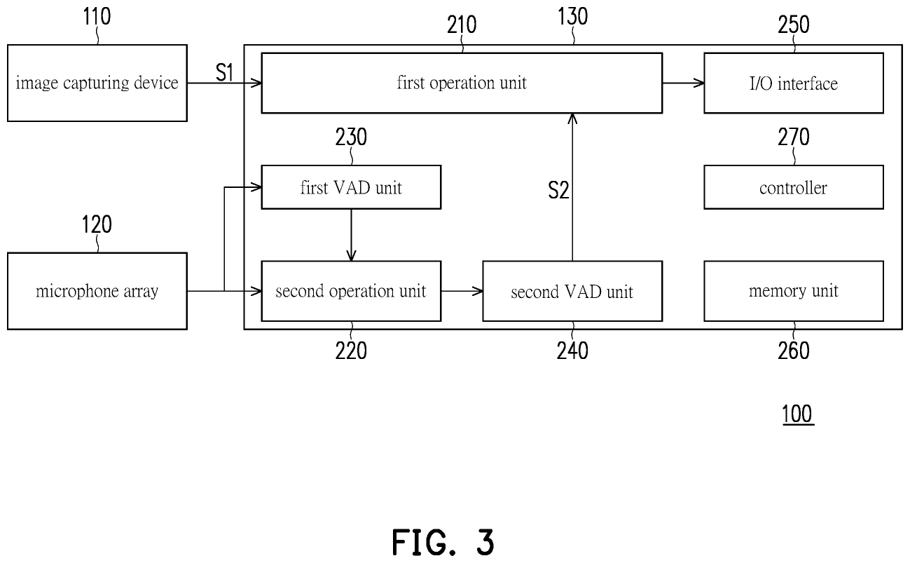

FIG. 3 illustrates a detail block diagram of the processing circuit of FIG. 1 according to embodiment of the invention. Referring to FIG. 3, the processing circuit 130 includes a first operation unit 210, a second operation unit 220, a first VAD unit 230, a second VAD unit 240, an input and output (I/O) interface 250, a memory unit 260, and a controller 270.

The controller 270 is configured to output comments to control all the units of the processor, the image capturing device 110 and the microphone array 120. For example, if the voice source is determined as a human voice, the controller 270 may control the image capturing device 110 to only capture the ROI image 310 according to the ROI setting signal S2. The control comments include location coordinates of the ROI, and thus corresponding image sensors of the image capturing device 110 are activated to capture the ROI image 310. Since the size of the activated image sensors and the amount of image data transmitted to the first operation unit 210 are small, power consumption and operation time of the image detecting apparatus 100 can be reduced.

In FIG. 3, the image capturing device 110 and the microphone array 120 are controlled by the controller 270, but for clarity, control lines among the image capturing device 110, the microphone array 120 and the controller 270 are not illustrated.

The image capturing device 110 may capture the ROI image 310 and output a image signal S1 to the first operation unit 210. The image signal S1 includes the image data of the ROI image 310. The first operation unit 210 receives the image signal S1 from the image capturing device 110. The first operation unit 210 performs a data analysis and an image process on the ROI image 310, thus power consumption and operation time of the image detecting apparatus 100 are reduced.

In an embodiment, the first operation unit 210 may have a face detection function or a face recognition function, and perform a face detection operation or a face recognition operation on the ROI image 310. The ROI image 310 is configured for face detection or face recognition. The detection result or the recognition result is outputted to the I/O interface 250. In the present embodiment, the image capturing device 110 simply captures the ROI image 310 according to the ROI setting signal S2 to further reduce power consumption and operation time. The ROI setting signal S2 includes indicates the location of the voice source.

In an embodiment, the controller 270 may control the image capturing device 110 to capture the whole image 300, and the first operation unit 210 determines the ROI image 310 according to the ROI setting signal S2 from the second VAD unit 240 and the received whole image 300.

The I/O interface 250 receives the detection result or the recognition result from the first operation unit 210 and outputs the detection result or the recognition result to other apparatuses. In an embodiment, the I/O interface 250 may be connected to a wireless communication module (not shown), such that the detection result or the recognition result can be wirelessly transmitted.

The second operation unit 220 performs the beamforming to generate the ROI setting signal S2, and the first VAD unit 230, and the second VAD unit 240 (can be omitted) perform the VAD to check whether the voice source is a preset type voice. For example, the voice source may be from the person P1.

To be specific, the microphone device 122 controlled by the controller 270 detects the voice source to generate a voice signal, and the first VAD unit 230 performs a first VAD process on the voice signal to determine whether the voice source is a preset type voice, e.g. human voice. The fast VAD process may include VAD based on thresholds and/or deep learning. The first VAD unit 230 may be implemented as hardware, but the invention is not limited thereto.

Next, when the voice source is determined as the human voice, the second operation unit 220 is triggered to receive the voice signals from all microphone devices 122 controlled by the controller 270, and determines the location of the voice source by beamforming and noise reduction.

In the beamforming operation, according to the voice signals detected by the microphone array 120, the orientation of the voice source in space can be obtained, and the voice signals can be fused to obtain a voice fusion representing multiple voice signals. The processing circuit 130 may perform the VAD to further confirm whether the voice source is the preset type voice on the voice fusion, and the voice fusion is generated from the beamforming operation.

To be specific, the second VAD unit 240 performs a second VAD process on the voice fusion to further confirm the type of the voice source. For example, the second VAD unit 240 may perform a VAD process with high accuracy to further confirm the type of the voice source. The VAD process with high accuracy may include VAD based on statistical model and/or deep learning. The second VAD unit 240 may be implemented as software, but the invention is not limited thereto. Accordingly, the second VAD unit 240 can perform the second VAD process on the voice fusion to further confirm the type of the voice source, and if the voice source is the human voice, the second VAD unit 240 generates and transmits the ROI setting signal S2 to the first operation unit 210. The ROI setting signal S2 includes an information of the location of the voice source.

Therefore, the first operation unit 210 can perform the data analysis and the image process on the ROI image 310, such that power consumption and operational time of the image detecting apparatus 100 can be reduced. The ROI image 310 can be obtained by activating some pixels to only capture the ROI image 310 according to the ROI setting signal S2, or activating all image pixels to capture the whole image 300 and further determining the ROI image 310 according to the ROI setting signal S2 and the whole image 300.

In an embodiment, the second VAD unit 240 is optional. That is to say, the second VAD unit 240 is omitted in the processing circuit 130, and the second operation unit 220 can directly generate and output the ROI setting signal S2 to the first operation unit 210 according to the location of the voice source without via the second VAD unit 240.

In addition, the memory unit 260 may include system memories and/or secure memories. The system memories store operation results. The secure memories store audio data and video data. Or, the secure memories store security protection encryption and decryption keys, e.g. one-time password (OTP).

In the disclosure, the circuit blocks of the processing circuit 130 may be a hardware circuit designed through Hardware Description Language (HDL) or any other design methods for digital circuit well-known to persons with ordinary skill in the art and may be implemented in from of Field Programmable Gate Array (FPGA), Complex Programmable Logic Device (CPLD) or Application-specific Integrated Circuit (ASIC). The circuit blocks of the processing circuit 130 may be, for example, a central processing unit (CPU), a programmable general-purpose or special-purpose microprocessor, a digital signal processor (DSP), a programmable controller, any other similar device, or a combination of said devices, and may be loaded to perform computer programs.

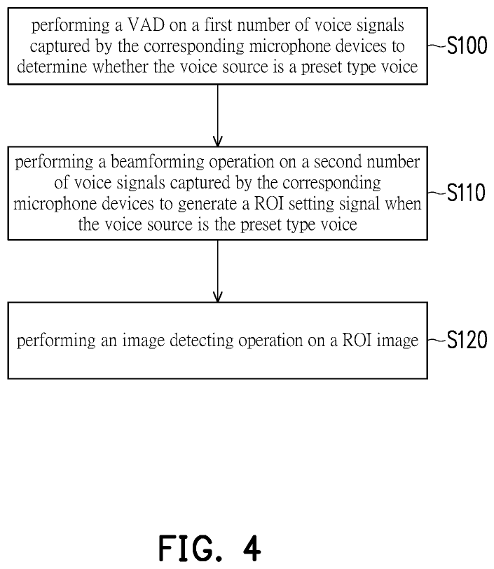

FIG. 4 is a flowchart illustrating an image detecting method according to an embodiment of the invention. Referring to FIG. 1 and FIG. 4, the image detecting method of the present embodiment is at least adapted to the image detecting apparatus 100 depicted in FIG. 1, but the disclosure is not limited thereto. Taking the image detecting apparatus 100 for example, in step S100, the processing circuit 130 performs a VAD on a first number of voice signals captured by the corresponding microphone devices to determine whether the voice source is a preset type voice. In an embodiment, the first number can be one. In step S110, the processing circuit 130 performs a beamforming operation on a second number of voice signals captured by the corresponding microphone devices to generate a ROI setting signal when the voice source is the preset type voice. In an embodiment, the second number can be the number of all microphone devices. In step S120, the processing circuit 130 performs an image detecting operation on a ROI image 310. The ROI image 310 may also indicate a ROI of the image 300.

The image detecting method described in the embodiment of the invention is sufficiently taught, suggested, and embodied in the embodiments illustrated in FIG. 1 to FIG. 3, and therefore no further description is provided herein.

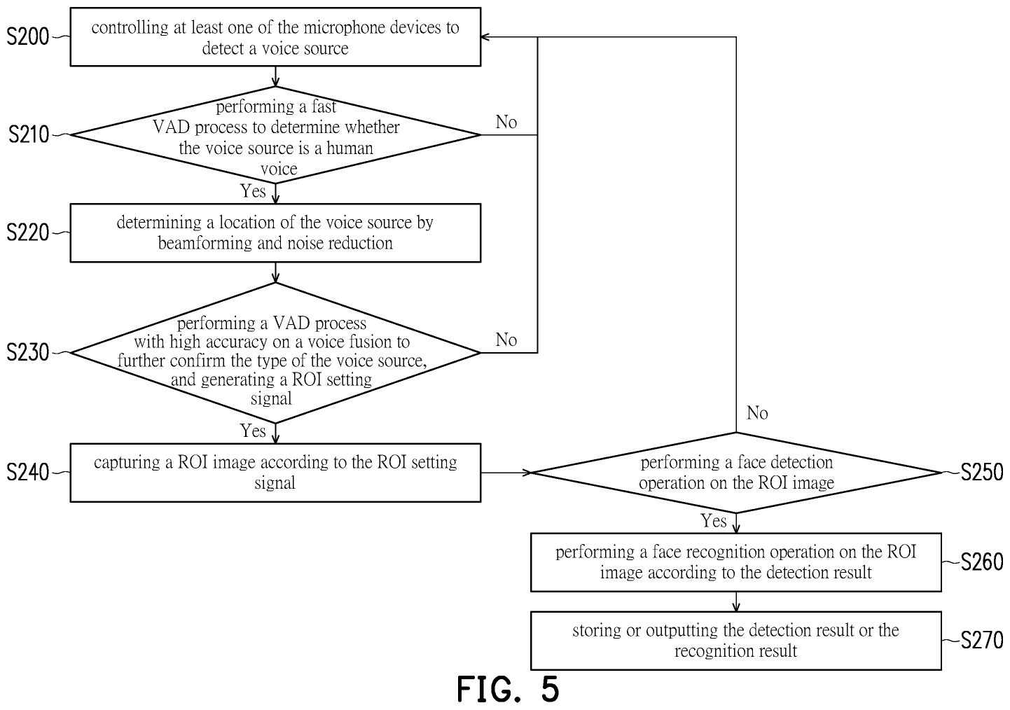

FIG. 5 is a flowchart illustrating an image detecting method according to another embodiment of the invention. Referring to FIG. 3 and FIG. 5, the image detecting method of the present embodiment is at least adapted to the image detecting apparatus 100 depicted in FIG. 3, but the disclosure is not limited thereto.

Taking the image detecting apparatus 100 for example, in step S200, the second operation unit 220 controls at least one of the microphone devices to detect a voice source. In step S210, the first VAD unit 230 performs a fast VAD process to determine whether the voice source is a human voice.

In step S210, when the voice source is determined as the human voice, the method flow goes to step S220. In step S220, the second operation unit 220 further receives the voice signals from all the microphone devices, and determines a location of the voice source in the image by beamforming and noise reduction. In the beamforming operation, the voice signals can be fused to obtain a voice fusion representing multiple voice signals. In step S210, when the voice source is not determined as the human voice, the method flow returns to step S200, and the second operation unit 220 controls at least one of the microphone devices to detect the voice source, again. That is to say, when the voice source is not the preset type voice, the method flow returns to the step of controlling the first number of the microphone devices to detect the voice source.

Next, in step S230, the second VAD unit 240 performs a VAD process with high accuracy on the voice fusion to further confirm the type of the voice source. In step S230, when the voice source is confirmed as the human voice, the location of the voice source from the second operation unit 220 is transmitted as a ROI setting signal S2, and the method flow goes to step S240. In step S240, the controller 270 controls the image capturing device 110 to capture the ROI image 310 according to the ROI setting signal S2. In step S230, when the voice source is not confirmed as the human voice, the method flow returns to step S200. In an embodiment, step S230 is optional.

In step S250, the first operation unit 210 perform a face detection operation on the ROI image 310 to reduce power consumption and operational time of the image detecting apparatus 100. When a face recognition operation is required, the method flow goes to step S260, and the first operation unit 210 perform the face recognition operation on the ROI image 310 according to the detection result. When the face recognition operation is not required, the method returns to step S200, and the image detecting apparatus 100 may start a new detecting flow. Next, the detection result in step S250 or the recognition result in step S260 may be stored or outputted to other apparatuses in step S270. In an embodiment, step S260 is optional.

The image detecting method described in the embodiment of the invention is sufficiently taught, suggested, and embodied in the embodiments illustrated in FIG. 1 to FIG. 4, and therefore no further description is provided herein.

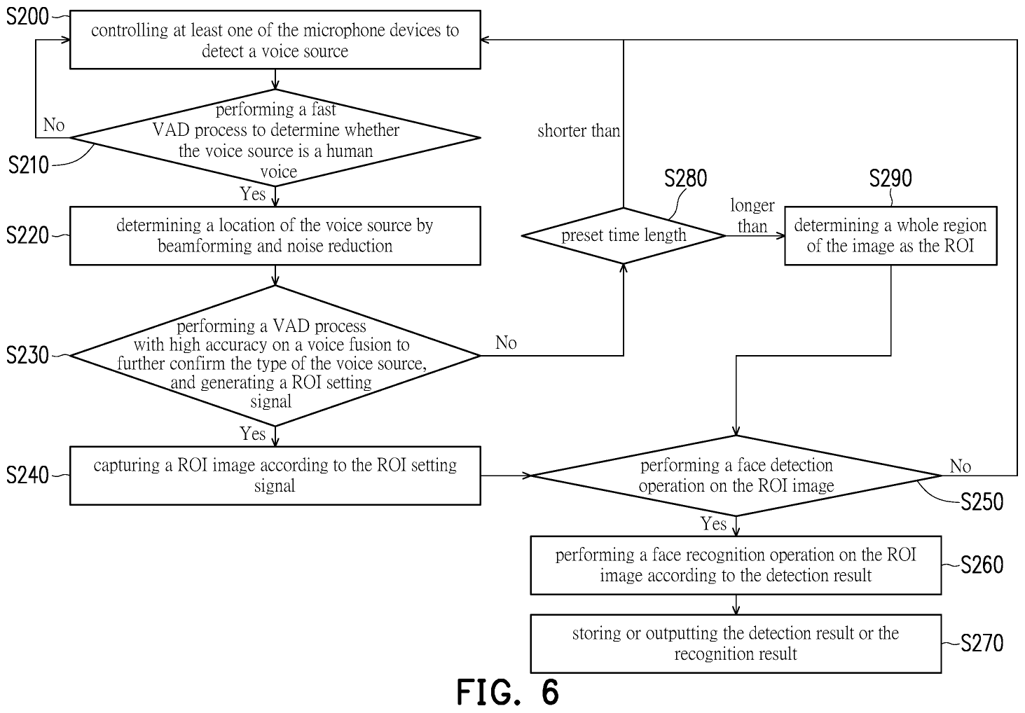

FIG. 6 is a flowchart illustrating an image detecting method according to another embodiment of the invention. Referring to FIG. 3 and FIG. 6, the image detecting method of FIG. 6 is similar to the image detecting method of FIG. 5, and the main difference therebetween, for example, lies in that the image detecting method of FIG. 6 further includes step S280 and step S290.

To be specific, in step S230, when the voice source is not confirmed as the human voice, the method flow goes to step S280. In step S280, when the type of the voice source is not confirmed for a preset time length, a whole region of the image 300 is determined as the ROI in step S290. For example, when the voice source is not confirmed as the human voice in step S230, the loop of step S200, step S210, step S220, step S230 and S280 are performed for the preset time length, e.g. 5 seconds. If the execution time of the loop does not exceed the preset time length, the loop will be performed continuously, and the method flow goes from step S280 to S200. If the execution time of the loop exceeds the preset time length, the loop will be stopped, and the method flow goes from step S280 to step S290.

In step S290, the first operation unit 210 determines a whole region of the image 300 as the ROI. That is to say, when the type of the voice source is not confirmed for the preset time length, the whole region of the image 300 is determined as the ROI. In other words, the processing circuit 130 may control the first number of the microphone devices 122 to detect the voice source in a periodic time, and when the type of the voice source are not confirmed for a preset time length, the processing circuit 130 determines a whole region of the image 300 as the ROI image 310.

The image detecting method described in the embodiment of the invention is sufficiently taught, suggested, and embodied in the embodiments illustrated in FIG. 1 to FIG. 5, and therefore no further description is provided herein.

In summary, in the embodiments of the invention, through audio microphone array positioning (Beamforming) and VAD detection, image detection region can be reduced the ROI range, the efficiency of image detection can be increased, and the overall performance of the apparatus can be improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An image detecting method, adapted to an image detecting apparatus, wherein the image detecting apparatus comprises an image capturing device and a microphone array, and the microphone array has a plurality of microphone devices, the image detecting method comprising:
performing a voice activity detection (VAD) on a first number of voice signals captured by the corresponding microphone devices to determine whether the voice source is a preset type voice, wherein the voice signals are from the voice source;
performing a beamforming operation on a second number of voice signals captured by the corresponding microphone devices to generate a region of interest (ROI) setting signal when the voice source is the preset type voice, wherein the ROI setting signal indicates a location of the voice source in an image captured by the image capturing device; and
performing an image detecting operation on a ROI image, wherein the ROI image is determined according to the image and the ROI setting signal,
wherein the first number is smaller than the second number.

2. The image detecting method of claim 1, further comprising:
only activing the first number of the microphone devices for the VAD; and
only activing the second of the microphone devices for the beamforming operation.

3. The image detecting method of claim 2, wherein the step of performing the VAD on the first number of voice signals captured by the corresponding microphone devices to determine whether the voice source is the preset type voice comprises:
controlling the first number of the microphone devices to detect the voice source in a periodic time.

4. The image detecting method of claim 1, further comprising:
performing the VAD to further confirm whether the voice source is the preset type voice on a voice fusion, wherein the voice fusion is generated from the beamforming operation.

5. The image detecting method of claim 1, wherein when the location of the voice source and a type of the voice source are not confirmed for a preset time length, a whole region of the image is determined as the ROI image.

6. The image detecting method of claim 1, wherein the step of performing the image detecting operation on the ROI image comprises:
capturing the whole image, and determining the ROI image according to the ROI setting signal and the received whole image.

7. The image detecting method of claim 1, wherein the step of performing the image detecting operation on the ROI image comprises:
capturing the ROI of the image according to the ROI setting signal.

8. The image detecting method of claim 1, wherein the ROI of the image is configured for face recognition.

9. An image detecting apparatus, comprising:
an image capturing device, configured to capture an image;
a microphone array, having a plurality of microphone devices, configured to detect a voice source; and
a processing circuit, coupled to the image capturing device and the microphone array, and configured to:
perform a voice activity detection (VAD) on a first number of voice signals captured by the corresponding microphone devices to determine whether the voice source is a preset type voice, wherein the voice signals are from the voice source;
performing a beamforming operation on a second number of voice signals captured by the corresponding microphone devices to generate a region of interest (ROI) setting signal when the voice source is the preset type voice, wherein the ROI setting signal indicates a location of the voice source in the image; and
perform an image detecting operation on a ROI image, wherein the ROI image is determined according to the image and the ROI setting signal,
wherein the first number is smaller than the second number.

10. The image detecting apparatus of claim 9, wherein the processing circuit only activates the first number of the microphone devices for the VAD, and only activates the second of the microphone devices for the beamforming operation.

11. The image detecting apparatus of claim 10, wherein the processing circuit controls the first number of the microphone devices to detect the voice source in a periodic time.

12. The image detecting apparatus of claim 9, wherein the processing circuit performs the VAD to further confirm whether the voice source is the preset type voice on a voice fusion, wherein the voice fusion is generated from the beamforming operation.

13. The image detecting apparatus of claim 9, wherein when the location of the voice source and a type of the voice source are not confirmed for a preset time length, the processing circuit determines a whole region of the image as the ROI image.

14. The image detecting apparatus of claim 9, wherein the processing circuit controls the image capturing device to capture the whole image, and determines the ROI image according to the ROI setting signal and the received whole image.

15. The image detecting apparatus of claim 9, wherein the processing circuit controls the image capturing device to capture the ROI image according to the ROI setting signal.

16. The image detecting apparatus of claim 9, wherein the processing circuit performs a face recognition operation according to the ROI image.
